(19) United States
(12) Patent Application Publication
(10) Pub. No.: US 2008/0079632 A1
(43) Pub. Date: Apr. 3, 2008

(54) DIRECTIONAL COUPLER FOR BALANCED SIGNALS

(75) Inventors: Herbert Jaeger, Prambachkirchen (AT); Marcus Hartmann, Uechtelhausen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Muenchen (DE)

(21) Appl. No.: 11/555,756

(22) Filed: Nov. 2, 2006

(30) Foreign Application Priority Data
Oct. 2, 2006 (DE) 10 2006 046 728.0

(51) Int. Cl. H01P 5/12; G01S 13/00

(52) U.S. Cl. 342/194; 333/116

(57) ABSTRACT

A directional coupler, for example a rat-race coupler, for use in radar engineering is disclosed. In one embodiment, the directional coupler includes at least three ports which are electrically connected to one another by a number of line branches, all line branches being constructed as balanced pairs of lines.

### TECHNICAL FIELD

The present invention relates to a directional coupler, for example a rat-race coupler, for use in radar engineering.

### BACKGROUND

Monostatic radars, i.e. radars which use the same antenna for transmitting and receiving, need a device for separating the transmit signals fed into the antenna from the receive signals received by the antenna.

Such send/receive duplexers frequently use materials such as, for example, certain insulators and ferrites which, however, cannot be integrated economically. Another possibility is the use of directional couplers, e.g., rat-race couplers or branchline couplers which are in most cases implemented on a high-frequency substrate separately from the chip in which the remaining transmit and receive electronics are accommodated.

Disadvantages of these implementations consist, on the one hand, in a relatively large space requirement in comparison with active integrated circuits (e.g., oscillators, amplifiers, mixers) and, on the other hand, in that they can only be used for unbalanced signals. There is thus a necessity for transforming balanced signals into unbalanced signals with the aid of baluns (balanced-to-unbalanced transformers). Furthermore, connecting high-frequency substrate and chip with only minimal losses in unbalanced signals represents a large hurdle in the design of RF circuits.

An unbalanced signal is understood to be a single signal referenced to ground, i.e. a voltage between two lines, one of which is at ground potential. Unbalanced signals are also called “single-ended”. A balanced signal is understood to be a signal between two lines, where both lines are modulated symmetrically with respect to a ground potential. Balanced signals are also called differential.

For these and other reasons, there is a need for the present invention.

### SUMMARY

One embodiment uses balanced (differential) pairs of lines in a directional coupler. The directional coupler according to the invention is a multiport (n-port) network having at least three ports which are electrically connected by a number of line branches, wherein all line branches are constructed as balanced pairs of lines.

In one embodiment of the invention, the balanced lines are constructed on a high-frequency substrate or directly on a semiconductor chip as coupled pairs of microstrip lines.

In a further embodiment of the invention, one pair of lines is crossed over in at least one branch in order to achieve an additional phase shift of 180° which corresponds to an electrical path length of a half wavelength. As a result, it is possible to shorten the pairs of lines by the distance of one half wavelength which entails the advantage of a considerable reduction in the space requirement for the directional coupler. The electrical characteristics of a directional coupler according to the invention, too, are better in comparison with conventional directional couplers. For example, due to the reduced line length, the associated line losses are also absent and the bandwidth of the directional coupler is also increased.

It is also a significant advantage of the directional coupler according to the invention that it can be implemented in a simple manner together with other circuit parts (oscillator, mixer etc.) on the same microchip.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a basic sketch of a rat-race coupler.

FIG. 2 illustrates an arrangement of a coupled pair of microstrip lines on a substrate.

FIG. 3 illustrates the diagrammatic representation of an implementation of a directional coupler according to the invention in stripline technology in a top view.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

One embodiment uses balanced (differential) pairs of lines in a directional coupler. The directional coupler according to the invention is a multiport (n-port) network having at least three ports which are electrically connected by a number of line branches, wherein all line branches are constructed as balanced pairs of lines.

In one embodiment of the invention, the balanced lines are constructed on a high-frequency substrate or directly on a semiconductor chip as coupled pairs of microstrip lines.

In a further embodiment of the invention, one pair of lines is crossed over in at least one branch in order to achieve an additional phase shift of 180° which corresponds to an electrical path length of a half wavelength. As a result, it is possible to shorten the pairs of lines by the distance of one half wavelength which entails the advantage of a considerable reduction in the space requirement for the directional coupler. The electrical characteristics of a directional coupler according to the invention, too, are better in comparison with conventional directional couplers. For example, due to the reduced line length, the associated line losses are also absent and the bandwidth of the directional coupler is also increased.

It is also a significant advantage of the directional coupler according to the invention that it can be implemented in a simple manner together with other circuit parts (oscillator, mixer etc.) on the same microchip.

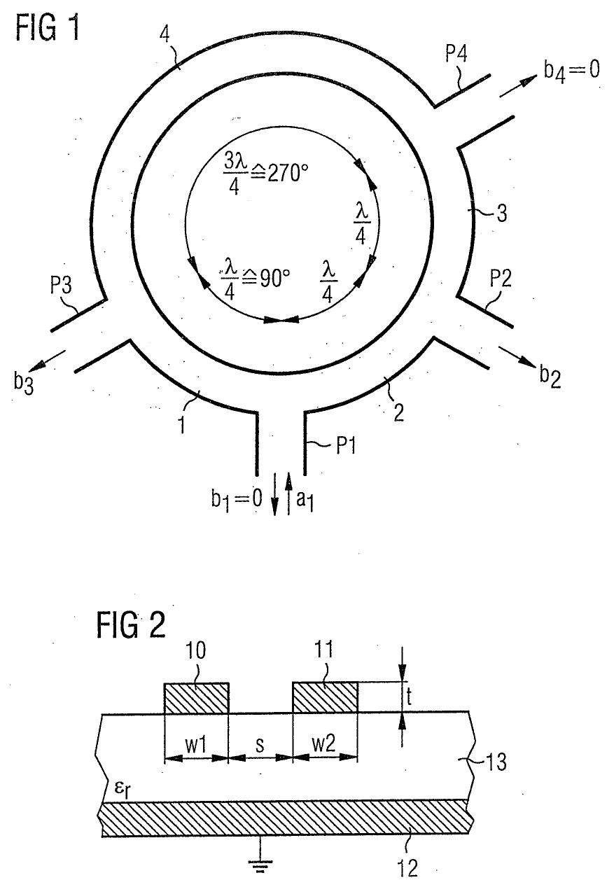

The principle of a ring-shaped directional coupler is illustrated in FIG. 1. The directional coupler comprises a first port P1, a second port P2, a third port P3 and a fourth port P4, wherein a first branch 1 connects the first port P1 and the third port P3, a second branch 2 connects the first port P1 and the second port P2, a third branch 3 connects the second port P2, and the fourth port P4 and a fourth branch 4 connects the fourth port P4 and the third port P3. The length of the fourth branch is three quarters of the wavelength λ for which the directional coupler is designed. The length of the remaining branches (1 to 3) is in each case one quarter of the wavelength λ. The fourth branch 4 thus produces a phase shift of 270° for a wave traveling through and the remaining branches (1 to 3) in each case produce a phase shift of 90°.

If, for example, a wave a1 is fed into the port P1, the power of the incident wave is ideally distributed uniformly to the second port P2 and the third port P3. The returning wave b2 in the second port P2 and the returning wave b3 in the third port P3 in each case have half the power of the wave a1 incident in the first port P1 and are phase-shifted by 180° with respect to one another. The power of the returning wave 4 in the fourth port P4 is zero, i.e. the fourth port P4 is insulated from the first port P1. In practice, the quality of the insulation is assessed with the aid of the coupling attenuation which, of course, should be as high as possible. The characteristic impedance of the line branches is ideally greater by a factor of root two than the terminating impedance of the port, i.e. the characteristic impedance of a line connected to the port is matched to the combined characteristic impedance of the line branches of the rat-race coupler. The reflection factor at a port is then ideally also zero, i.e. for the example given above, the returning wave b1 is zero in the first port P1.

FIG. 1 illustrates the basic structure of a rat-race coupler. The coupler is a four-port network with a first port P1, a second port P2, a third port P3 and a fourth port P4, wherein a first branch (1) connects the first port (P1) and the third port (P3), a second branch (2) connects the first port (P1) and the second port (P2), a third branch (3) connects the second port (P2), and the fourth port (P4) and a fourth branch (4) connects the fourth port (P4) and the third port (P3). Incident waves are designated by the letter “a”, returning waves have the letter “b”, the index represents the port to which the information is related. A wave a1 incident, for example, in the first port P1 produces two returning waves b2 and b3, which are shifted by 180° with respect to one another, at the ports P2 and P3. In an ideal coupler, the power of the returning waves b2 and b3 is 50% each of the power of the incident wave a1. The wave b2 reflected at the first port P1 is ideally zero exactly like the wave b4 returning from the fourth port P4. The length of the branches 1 to 3 is in each case a quarter of the wavelength λ of the frequency for which the rat-race coupler is designed, i.e. the branches 1 to 3 produce a phase shift of 90° in the transmitted signal. The length of the fourth branch is three quarters of the wavelength λ. According to the present invention, the branches of the directional coupler according to the invention are constructed of balanced (differential) pairs of lines.

Such balanced pairs of lines can be produced very simply, for example, in microstrip line technology. FIG. 2 illustrates the basic arrangement of a coupled pair of microstrip lines on a high-frequency substrate 13 (or on a microchip). On one side of a high-frequency substrate 13 with the relative permittivity εᵣ, two essentially parallel striplines 10 and 11 are arranged. On the surface of the substrate opposite to the striplines 10 and 11, a ground area 12 is located. The striplines have essentially a rectangular cross section with a line width w1 and w2, respectively, and a line thickness t. The two striplines extend essentially in parallel with one another with a spacing s. The cross section of the striplines does not necessarily need to be rectangular but the characteristic impedance of the line can be adjusted well by means of a simple geometry.

However, the striplines do not necessarily have to form a ring-shaped structure as is illustrated in FIG. 1 but can be applied to the substrate in any form. The essential factor is only the line length between the ports (P1 to P4). In particular, the coupled pairs of microstrip lines can be applied in rectangular form or “folded” (e.g., meander-shaped) in order to minimize the required space on the substrate or the microchip, respectively.

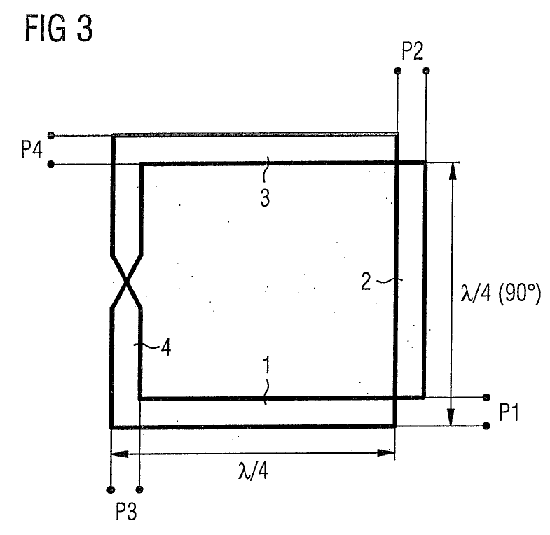

FIG. 3 illustrates an implementation of the directional coupler according to the invention in microstrip line technology as a top view. The four branches 1, 2, 3 and 4 which connect the four ports P1, P2, P3 and P4 essentially form the side edges of a square. The first line branch 1 connects the first port P1 and the third port P3, the second line branch 2 connects the first port P1 and the second port P2, the third line branch 3 connects the second port P2 and the fourth port P4, and the fourth line branch 4 connects the fourth port P4 and the third port P3. The side length of the square is one quarter of the wavelength λ of the signal processed, i.e. the electrical path length of the first line branch 1, of the second line branch 2 and of the third line branch 3 is in each case λ/4. To achieve an electrical path length of 3λ/4 between the fourth port P4 and the third port P3 as in FIG. 1, the coupled pair of microstrip lines is crossed over once in the fourth line branch which produces an additional 180° phase shift corresponding to an electrical path length of λ/2. Such a crossover can be implemented in a simple manner by using a multi-layer metallization which has a number of metallization layers with interposed insulation layers in order to enable conductor tracks to cross over without short circuit.

The square structure is to be considered only as an example and not to be considered as a restriction. Naturally, the directional coupler can have any shape on the substrate as long as only the required electrical path lengths are maintained between the individual ports. Crossing over a balanced pair of lines in a line branch makes it possible to shorten the actual line length by a half wavelength λ since the phase shift of 180° associated with the crossover corresponds to an electrical path length of λ/2. Due to this measure, an additional reduction in the space requirement is achieved.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A directional coupler comprising:
at least three ports electrically interconnected by a number of line branches; and
wherein all of the line branches are constructed as balanced pairs of lines.

2. The directional coupler of claim 1, comprising wherein one of the pairs of lines is crossed over in at least one of the line branches.

3. The directional coupler of claim 1, comprising constructing the line branches as coupled pairs of microstrip lines on a high-frequency substrate.

4. The directional coupler of claim 1, comprising constructing the line branches as coupled pairs of microstrip lines on a microchip.

5. A directional coupler comprising:
a first port, a second port, a third port, and a fourth port;
a first line branch, a second line branch, a third line branch, and a fourth line branch; and
wherein the first line branch connects the first port and the third port, the second line branch connects the first port and the second port, the third line branch connects the second port and the fourth port, and the fourth line branch connects the fourth port and the third port.

6. The directional coupler of claim 5, comprising:
wherein the length of the fourth line branch is selected such that a phase shift of 270° is produced in a signal transmitted via the forth line branch.

7. The directional coupler of claim 6, comprising:
wherein the length of the other line branches than the fourth line branch is selected such that a phase shift of 90° is in each case produced in a signal transmitted via the other branches.

8. The directional coupler of claim 7, comprising:
wherein all of the line branches are constructed as balanced pairs of lines.

9. The directional coupler of claim 8, comprising:
wherein the length of the first line branch, of the second line branch and of the third line branch is in each case one quarter of the wavelength which the directional coupler is designed for; and
wherein the length of the fourth line branch is three quarters of the wavelength.

10. The directional coupler of claim 8, comprising:
in which the length of the first line branch, of the second line branch and of the third line branch is in each case one quarter of the wavelength the directional coupler is designed for; and
wherein the length of the fourth line branch is also one quarter of the wavelength and the pair of lines of the fourth line branch is crossed over.

11. The directional coupler of claim 8, comprising:
a connector for coupling a radar to the directional coupler.

12. A microchip system comprising:
a microchip;
a directional coupler integrated in the microchip, the directional coupler comprising at least three ports which are electrically interconnected by a number of line branches which are constructed as balanced pairs of lines; and
other circuit components also integrated in the microchip.

13. The microchip as of claim 8, wherein the circuit components comprise at least one of a mixer, an oscillator, or a power divider.

14. A radar system comprising:
a radar;
a radar antenna; and
a directional coupler for separating antenna signals, comprising a first port, a second port, a third port, and a fourth port; a first line branch, a second line branch, a third line branch, and a fourth line branch; and wherein the first line branch connects the first port and the third port, the second line branch connects the first port and the second port, the third line branch connects the second port and the fourth port, and the fourth line branch connects the fourth port and the third port.

15. The system of claim 14, comprising:
wherein the length of the fourth line branch is selected such that a phase shift of 270° is produced in a signal transmitted via the forth line branch.

16. The system of claim 14, comprising:
wherein the length of the other line branches than the fourth line branch is selected such that a phase shift of 90° is in each case produced in a signal transmitted via the other branches.

17. The system of claim 16, comprising:
wherein all of the line branches are constructed as balanced pairs of lines.

18. The system of claim 17, comprising:
wherein the length of the first line branch, of the second line branch and of the third line branch is in each case one quarter of the wavelength which the directional coupler is designed for; and
wherein the length of the fourth line branch is three quarters of the wavelength.

19. The directional coupler of claim 17, comprising:
in which the length of the first line branch, of the second line branch and of the third line branch is in each case one quarter of the wavelength the directional coupler is designed for; and
wherein the length of the fourth line branch is also one quarter of the wavelength and the pair of lines of the fourth line branch is crossed over.

20. The system of claim 17, comprising:
a connector for coupling the radar to the directional coupler.

21. A directional coupler comprising:
means for providing at least three ports electrically interconnected by a number of line branches; and
means for constructing all of the line branches as balanced pairs of lines.
